(19) United States
(12) Patent Application Publication
(10) Pub. No.: US 2024/0314251 A1
(43) Pub. Date: Sep. 19, 2024

(54) IMAGE FORMING APPARATUS AND METHOD OF CONTROLLING IMAGE FORMING APPARATUS

(71) Applicant: CANON KABUSHIKI KAISHA, Tokyo (JP)

(72) Inventor: AKINORI TAKEO, Kanagawa (JP)

(21) Appl. No.: 18/606,453

(22) Filed: Mar. 15, 2024

(30) Foreign Application Priority Data
Mar. 17, 2023 (JP) 2023-042822

(51) Int. Cl. H04N 1/21; G06F 3/12; H04N 1/00

(52) U.S. Cl. CPC H04N 1/2187; G06F 3/1207; G06F 3/121; G06F 3/1234; G06F 3/1238; G06F 3/1267; G06F 3/1288; H04N 1/00217

(57) ABSTRACT

An image forming apparatus includes at least a processor and at least a memory coupled to the at least the processor and having stored thereon instructions, when executed by the at least the processor, and cooperating to act as: an identifying unit configured to identify, when data is manipulated in a storage section, the storage section in which the data has been manipulated, from among a plurality of storage sections, an acquirer configured to acquire information indicating a notification destination corresponding to the storage section identified by the identifying unit, based on setting information in which a notification destination is set for each of the storage sections, and a transmitter configured to transmit, to the notification destination indicated by the information acquired by the acquirer, notification information indicating that the data has been manipulated.

### BACKGROUND

### Field

The present disclosure relates to an image forming apparatus and a method of controlling an image forming apparatus.

### Description of the Related Art

There is a use case in which a workflow is performed in which a user uses a network to remotely store a document to a document storage folder of an image forming apparatus, and another user uses the image forming apparatus to print and output the stored document and signs and submits the document after the document is printed and output. In this case, for document management, the document storage folder that is a storage destination of the document is used separately by each worker or each work group.

Japanese Patent Laid-Open No. 2006-215829 describes a document management apparatus that determines whether a destination notification document is stored in a folder when a document file is registered in the folder, and notifies the destination notification document to a destination based on the destination notification document when the document management apparatus determines that the destination notification document is stored in the folder.

The techniques and mechanisms described in Japanese Patent Laid-Open No. 2006-215829 has some issues. For example, a user may want to notify another worker that the document file has been registered in the folder and have the worker continue to print and output the registered document file. However, in system described in Japanese Patent Laid-Open No. 2006-215829, after the notification of the registration of the document file, the destination of the notification is determined based on the destination notification document set by the user who has stored the document file. Therefore, even when the document file is registered in a folder that is not a work target, the registration of the document file is still notified and thus the worker needs to separately confirm whether the notified document file is a document that is a work target of the worker.

### SUMMARY

The present disclosure describes techniques and mechanisms capable of transmitting notification information to a notification destination appropriate for each storage section.

In various embodiments of the present disclosure, an image forming apparatus is provided that includes at least a processor and at least a memory coupled to the at least the processor and having stored thereon instructions, when executed by the at least the processor, and cooperating to act as: an identifying unit configured to identify, when data is manipulated in a storage section, the storage section in which the data has been manipulated, from among a plurality of storage sections, an acquirer configured to acquire information indicating a notification destination corresponding to the storage section identified by the identifying unit, based on setting information in which a notification destination is set for each of the storage sections, and a transmitter configured to transmit, to the notification destination indicated by the information acquired by the acquirer, notification information indicating that the data has been manipulated.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a printing system according to one embodiment.

FIG. 2 is a diagram illustrating an example of a configuration of each terminal device according to one embodiment.

FIG. 3 is a diagram illustrating an example of a configuration of a message server according to one embodiment.

FIG. 4 is a diagram illustrating an example of a configuration of an image forming apparatus according to one embodiment.

FIG. 5 is a diagram illustrating a sequence according to one embodiment.

FIG. 6 is a diagram illustrating an example of an operation according to one embodiment.

FIG. 7 is a diagram illustrating an example of setting values according to one embodiment.

FIG. 8 is a diagram illustrating an example of a setting screen for setting values according to one embodiment.

FIG. 9 is a flowchart illustrating a method of controlling the image forming apparatus according to one embodiment.

FIG. 10 is a diagram illustrating a sequence according to one embodiment.

FIG. 11 is a diagram illustrating an example of an operation according to one embodiment.

FIG. 12 is a diagram illustrating an example of a screen according to one embodiment.

FIG. 13 is a flowchart illustrating a method of controlling an image forming apparatus according one embodiment.

### DESCRIPTION OF THE EMBODIMENTS

Hereinafter, embodiments are described with reference to the drawings. In each of the embodiments, a printing system is described as an example.

### First Embodiment

### Overall Configuration

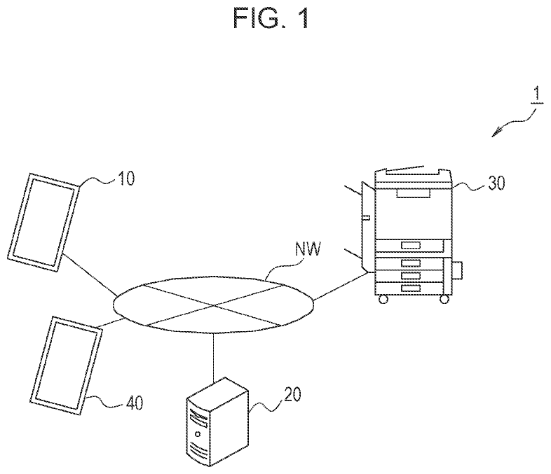

FIG. 1 is a diagram illustrating an example of a configuration of a printing system 1 according to one embodiment. As illustrated in FIG. 1, the printing system 1 includes terminal devices 10 and 40, a message server 20, and an image forming apparatus 30. The terminal devices 10 and 40, the message server 20, and the image forming apparatus 30 are connected to each other via a network NW. The network NW is an external network such as the Internet as an example, but may be a network other than the external network such as the Internet. For example, the network NW may be a local area network (LAN) or may be another communicable means (for example, the Internet network via an external network such as a Long Term Evolution (LTE) network or a 5G network) instead of the LAN.

The terminal devices 10 and 40 are information processing devices that are operated by users. Each of the terminal devices 10 and 40 is a device such as a smartphone, a tablet, or a personal computer (PC). Each of the terminal devices 10 and 40 can store document data to the image forming apparatus 30 as an external apparatus via the network NW.

Each of the terminal devices 10 and 40 can communicate a message with the image forming apparatus 30 by using an application (hereinafter referred to as a “messenger application”) for using a service (hereinafter referred to as a “messaging service”) that enables transmission and reception of a message. The messaging service may be provided as a single service or may be provided as one of multiple functions, like a social networking service.

A user of the messaging service executes the messenger application and posts a message to the messaging service via the messenger application. In the present embodiment, the message is data that is posted to the messaging service by the user who uses the messaging service. The message includes information indicating a sender of the message, information indicating a destination of the message, and information such as the content (posted content) of the message.

The message posted to the messaging service is stored in the messaging service. The user of the messaging service requests a message that is among messages posted to the messaging service and indicates a destination who is the user. The messaging service transmits, to a terminal device that is operated by the user, the message in which the user who requested the message is a destination of the message. In this manner, the transmission and reception of the message are implemented.

The posted content included in the message is, for example, text data entered by the user. The posted content can be image data. In the present embodiment, a message in which posted content is text data is referred to as a text message, and a message in which posted content is image data is referred to as an image message.

In the image message, the image data may be the posted content or information indicating the image data may be the posted content. The information indicating the image data is information (for example, a file path or a uniform resource locator (URL)) indicating a storage location at which the image data is stored, or an attribute (for example, the data size, format, hash value, or the like of the image data) of the image data.

The posted content may include a combination of a plurality of information items of the information described above. In a case where the image message in which the information indicating the image data is the posted content is posted, the image data is attached to the image message and transmitted to the messaging service. To transmit the image data attached to the message, the terminal device 10 or 40 may transmit the message and the image data to the message server 20 at the same time or at different times.

In any of the above-described cases, the posted image data can be identified based on the information indicating the image data included in the posted content of the image message. In a case where the posted content of the image message is the information indicating the image data, the messenger application acquires the image data based on the information indicating the image data. In the present embodiment, although the image data is transmitted, the image data may be content data that is moving picture data, audio data, or the like and is, for example, displayed by the messenger application performing display and reproduction processing.

The information indicating the sender of the message and the information indicating the destination of the message may be information regarding accounts. The accounts indicate users who use the messaging service. The information regarding the accounts is information that can identify the users who use the messaging service, and is account names, mail addresses, or serial numbers that can uniquely identify the users. The information regarding the accounts may be information including a plurality of information items that are combinations of user IDs and serial numbers.

The destination of the message may be a plurality of users. For example, as the destination of the message, a plurality of account names may be included in the message, or, for example, information corresponding to one or more accounts, such as a name of a chat room, a name of a talk room, or a name of a group, may be included in the message.

In the present embodiment, a case is described in which a message includes account names as information indicating a sender of the message and information indicating a destination of the message, and a user who is the destination of the message and a user who is the sender of the user can be identified by the account names. Each of the account names is a character string including an alphabet, a number, and a symbol. The account names may be determined by the users in order for the users to use the messaging service. Alternatively, the account names may be determined by the messaging service.

The message server 20 provides the messaging service and stores a message posted from a device connected to the message server 20. When the message server 20 is requested to provide a message from a device that uses the messaging service, the message server 20 transmits the message to the device that requested the message. In this case, the message server 20 may transmit a message in which a user who uses the device that requested the message is designated as a destination of the message.

The image forming apparatus 30 forms an image based on image data input from an external on printing paper or the like. In the present embodiment, the image forming apparatus 30 forms, on printing paper, an image based on document data transmitted from the terminal devices 10 and 40 via the network NW and image data included in messages transmitted from the terminal devices 10 and 40 via the network NW.

In the present embodiment, a message in which information indicating a sender of the message and information indicating a destination of the message are included in text data and image data is posted (transmitted). However, as long as a format from which the sender, the destination, and posted content can be identified is used, the format may not be a message format. For example, only the image data may be posted (transmitted), the sender may be identified from an IP address of a user who posted the image data, and the destination may be identified from a name of a talk room displayed when an operation of posting the image data is performed.

### Configuration of Each Terminal Device

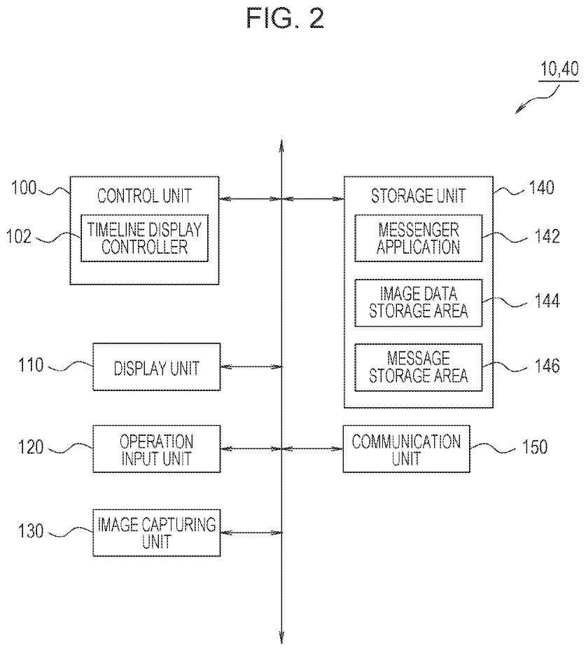

FIG. 2 is a diagram illustrating an example of a configuration of each of the terminal devices 10 and 40. As illustrated in FIG. 2, each of the terminal devices 10 and 40 includes a control unit 100, a display unit 110, an operation input unit 120, an image capturing unit 130, a storage unit 140, and a communication unit 150 that are coupled to each other via a bus.

The control unit 100 is a functional unit that controls the entire terminal device 10 or the entire terminal device 40. The control unit 100 implements various functions by reading and executing various programs. For example, the control unit 100 includes one or more computing devices (central processing units (CPUs)) or the like.

The control unit 100 also function as a timeline display controller 102 by executing the messenger application 142 described later. The timeline display controller 102 reads messages stored in a message storage area 146 and controls the display unit 110 to display the messages in the order of transmission dates and times of the messages. In the present embodiment, messages that are displayed in chronological order are referred to as a “timeline”. The timeline display controller 102 may display the messages in a speech bubble or a predetermined drawing as the timeline. For example, in a case where the messages are text messages, the timeline display controller 102 may perform control to display, in a speech bubble, text data that is posted content. In a case where the messages are image messages, the timeline display controller 102 may control the display unit 110 to display, in a speech bubble, image data based on posted content.

The timeline display controller 102 may read the messages stored in the message storage area 146 at a predetermined time and perform control to re-display (update) the timeline. The timeline display controller 102 may control the display unit 110 to re-display the timeline when a message is transmitted and received. The timeline display controller 102 may periodically control the display unit 110 to re-display the timeline. The timeline display controller 102 may control the display unit 110 to re-display the timeline when the user performs an operation of re-displaying the timeline.

The display unit 110 is a functional unit that displays various types of information to the user. For example, the display unit 110 includes a liquid crystal display (LCD) or the like.

The operation input unit 120 is a functional unit for the user to perform various operations. For example, the operation input unit 120 includes a touch panel disposed on and overlapping the display unit 110. Detection of a touch by the touch panel is implemented by a known technique such as an electrostatic dielectric method or a pressure sensitive method. The operation input unit 120 may include various operation devices such as a mouse and a keyboard.

The image capturing unit 130 is a functional unit that outputs, as image data, an image input from an image input apparatus such as a camera to the control unit 100. The image input apparatus may be disposed in the terminal device 10 or 40 or may be connected to the terminal device 10 or 40.

The storage unit 140 is a functional unit that stores various programs necessary for an operation of the terminal device 10 or 40 and various data. The storage unit 140 includes, for example, a solid-state drive (SSD) that is a semiconductor memory, a hard disk drive (HDD), or the like.

In the storage unit 140, the messenger application 142 is stored and an image data storage area 144 and a message storage area 146 are secured.

The messenger application 142 provides a function of transmitting and receiving a message to and from the messaging service. For example, the messenger application 142 has a function of posting (transmitting), to the messaging service, a message including content posted by the user from the operation input unit 120. The messenger application 142 has a function of causing the control unit 100 to function as the timeline display controller 102 to display messages acquired from the messaging service as a timeline.

The messenger application 142 may have another function. For example, the messenger application 142 may have a function of managing a destination of a message and a function of displaying information indicating that a message is notified to the display unit 110 when the terminal device 10 or 40 receives the message.

In the image data storage area 144, image data is stored. The image data stored in the image data storage area 144 may be image data output by the image capturing unit 130 or may be image data received by the communication unit 150.

In the message storage area 146, a message transmitted and received via the message application 142 is stored.

The message may include information other than information such as posted content, an account name of a destination of the message, an account name of a sender of the message, and a transmission date and time of the message. For example, the message may include identification information uniquely identifying the message, information indicating whether the message has been viewed, such as information indicating whether the message has been transmitted and information indicating whether the message has been read, and a hash value that enables the validity of the message to be verified.

The communication unit 150 is a functional unit for the terminal device 10 or 40 to communicate with an external device. For example, the communication unit 150 includes a communication module that can be connected to an NIC used in a wireless LAN, at least any one of LTE, LTE-A, LAA-LTE, and 5G lines, or the like. NIC described above is an abbreviation for Network Interface Card. LTE described above is an abbreviation for Long Term Evolution. LTE-A described above is an abbreviation for LTE-Advanced. LAA-LTE described above is an abbreviation for License-Assisted Access using LTE.

### Configuration of Message Server

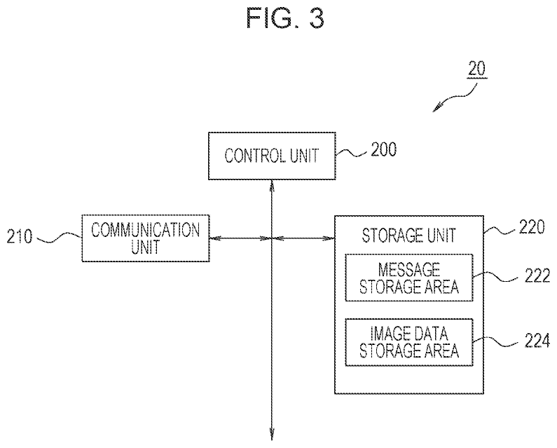

FIG. 3 is a diagram illustrating an example of a configuration of the message server 20. As illustrated in FIG. 3, the message server 20 includes a control unit 200, a communication unit 210, and a storage unit 220 that are coupled to each other via a bus.

The control unit 200 is a functional unit that controls the entire message server 20. The control unit 200 implements various functions by reading and executing various programs and includes, for example, one or more computing devices (CPUs) or the like.

The communication unit 210 is a functional unit for the message server 20 to communicate with an external device. For example, the communication unit 210 includes a communication module that can be connected to an NIC used in a wireless LAN, at least any one of LTE, LTE-A, LAA-LTE, and 5G lines, or the like.

The storage unit 220 is a functional unit that stores various programs necessary for an operation of the message server 20 and various data. The storage unit 220 includes, for example, a solid-state drive (SSD) that is a semiconductor memory, a hard disk drive (HDD), or the like. In the storage unit 220, a message storage area 222 and an image data storage area 224 are secured.

In the message storage area 222, a message is stored. Regarding a data configuration of the message, a message is stored for each user or each group in the message storage area 222. The message itself is similar to a message stored in the message storage area 146 illustrated in FIG. 2. However, the message stored in the message storage area 222 may include information necessary for management or the like.

In the image data storage area 224, image data transmitted in the format in which the image data is attached to an image message is stored. In the image data storage area 224, image data is stored for each user or each group. In the image data storage area 224, image data that corresponds to a user and is identical to image data stored in the image data storage area 144 illustrated in FIG. 2 is stored.

### Configuration of Image Forming Apparatus

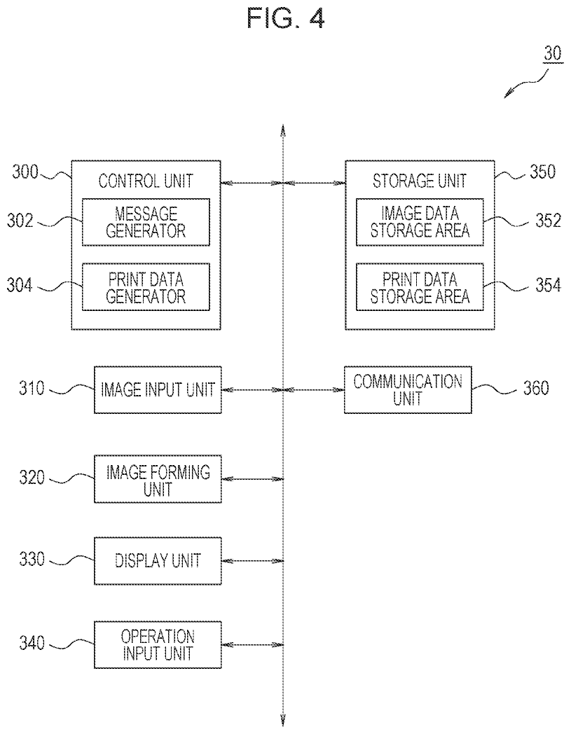

FIG. 4 is a diagram illustrating an example of a configuration of the image forming apparatus 30. As illustrated in FIG. 4, the image forming apparatus 30 includes a control unit 300, an image input unit 310, an image forming unit 320, a display unit 330, an operation input unit 340, a storage unit 350, and a communication unit 360 that are coupled to each other via a bus.

The control unit 300 is a functional unit that controls the entire image forming apparatus 30. The control unit 300 implements various functions by reading and executing various programs and includes, for example, one or more computing devices (CPUs) or the like. The control unit 300 functions as a message generator 302 and a print data generator 304 by reading and executing software (program) stored in the storage unit 350.

The message generator 302 generates a message. For example, upon acquiring a message from the message server 20 via the communication unit 360, the message generator 302 generates a message indicating a response to the acquired message. Then, the control unit 300 transmits the message generated by the message generator 302 to the message server 20 via the communication unit 360. The terminal device 10 or the terminal device 40 receives the message from the message server 20. Therefore, the image forming apparatus 30 can respond to a message transmitted by the terminal device 10 or the terminal device 40.

The print data generator 304 generates print data based on image data and document data stored in an image data storage area 352 and a message regarding a setting for printing of image data transmitted from the terminal device 10 or the terminal device 40. For example, the print data generator 304 enlarges or reduces the image data based on the size of printing paper to generate print data. The print data generator 304 may generate print data obtained by synthesizing a plurality of image data pieces in order to implement collective printing or may generate print data of an achromatic color by converting a chromatic color from image data including the chromatic color.

The image input unit 310 is a functional unit that reads an original document input to the image forming apparatus 30 and generates image data. For example, the image input unit 310 is connected to a document scanning device (for example, a scanner) for reading an image of an original document and generates image data output from the document scanning device. The image input unit 310 may generate image data based on data (document data) transmitted from another terminal via the communication unit 360 or may acquire image data from a Universal Serial Bus (USB) memory or a storage medium such as a memory card.

The image forming unit 320 is a functional unit that forms an image on a storage medium (for example, printing paper) using the print data. For example, the image forming unit 320 feeds printing paper from a paper feed tray, forms an image on a surface of the printing paper, and discharges, from a paper discharge tray, the printing paper on which the image has been formed. For example, the image forming unit 320 includes a laser printer that uses an electrophotographic method.

The display unit 330 is a functional unit that displays various types of information to a user. For example, the display unit 330 includes a liquid crystal display (LCD), an organic electro-luminescence (EL) panel, or the like.

The operation input unit 340 is a functional unit for the user to perform various operations. For example, the operation input unit 340 includes a touch panel disposed on and overlapping the display unit 330. Detection of a touch by the touch panel is implemented by a known technique such as an electrostatic dielectric method or a pressure sensitive method.

The storage unit 350 is a functional unit that stores various programs necessary for an operation of the image forming apparatus 30 and various data. The storage unit 350 includes a solid-state drive (SSD) that is a semiconductor memory, a hard disk drive (HDD), or the like. In the storage unit 350, the image data storage area 352 and a print data storage area 354 are secured.

In the image data storage area 352, image data generated by the image input unit 310 is stored. In the image data storage area 352, not only the image data generated by the image input unit 310 but also document data received from an external via the communication unit 360 are stored.

In the print data storage area 354, the print data generated by the print data generator 304 is stored. The print data is used for the image forming apparatus 320 to form the image on printing paper, for example.

The communication unit 360 is a functional unit for the image forming apparatus 30 to communicate with an external device. For example, the communication unit 360 includes a communication module that can be connected to an NIC used in a wireless LAN, at least any one of LTE, LTE-A, LAA-LTE, and 5G lines, or the like.

### Process Procedure

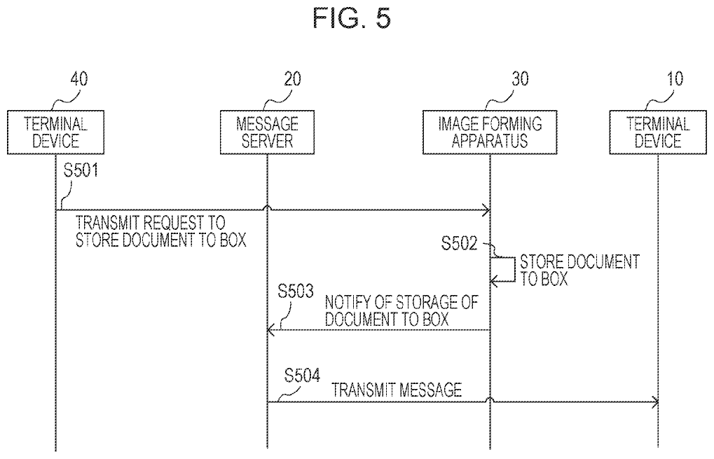

FIG. 5 is a sequence diagram illustrating a process procedure of the terminal devices 10 and 40, the message server 20, and the image forming apparatus 30 according to one embodiment. The users of the terminal devices 10 and 40 and the image forming apparatus 30 are users of the messaging service. Account names are allocated to the users. The users of the terminal devices 10 and 40 and the image forming apparatus 30 can transmit and receive messages to and from each other via the messaging service.

In the following description, it is assumed that posted content included in an image message is information indicating image data and that the image data is attached to the image message and transmitted to the message server 20.

In the following description, the account names corresponding to the users of the terminal devices 10 and 40 are merely referred to as the account names of the users, and the account name corresponding to the image forming apparatus 30 are merely referred to as the account name of the image forming apparatus 30.

A process of transmitting document data by the terminal device 40 to the image forming apparatus 30 and storing the document data by the image forming apparatus 30 is described with reference to FIG. 5. In FIG. 5, in the terminal device 10 and the terminal device 40, the control units 100 execute the messenger application 142. Therefore, the users can enter content to be posted.

In step S501, the terminal device 40 transmits a request to store a document to a box No. 00 of the image forming apparatus 30 together with document data via the network NW. The box is a storage section of a logical management unit in the print data storage area 354. For example, 100 boxes No. 00 to No. 99 are prepared, document data can be managed for each of the boxes, and a management setting can be set for each of the boxes. The boxes are, for example, document storage folders. An access right can be set for each of the boxes. Access to document data stored in each of the boxes is limited in accordance with the rights to access the boxes. The terminal device 40 directly transmits the request to store the document to the image forming apparatus 30 such that the request does not pass through the message server 20. However, the terminal device 40 may transmit the request to store the document to the image forming apparatus 30 via the message server 20.

In step S502, the image forming apparatus 30 stores, in the image data storage area 352, the document data transmitted together with the request to store the document to the box No. 00 in step S501.

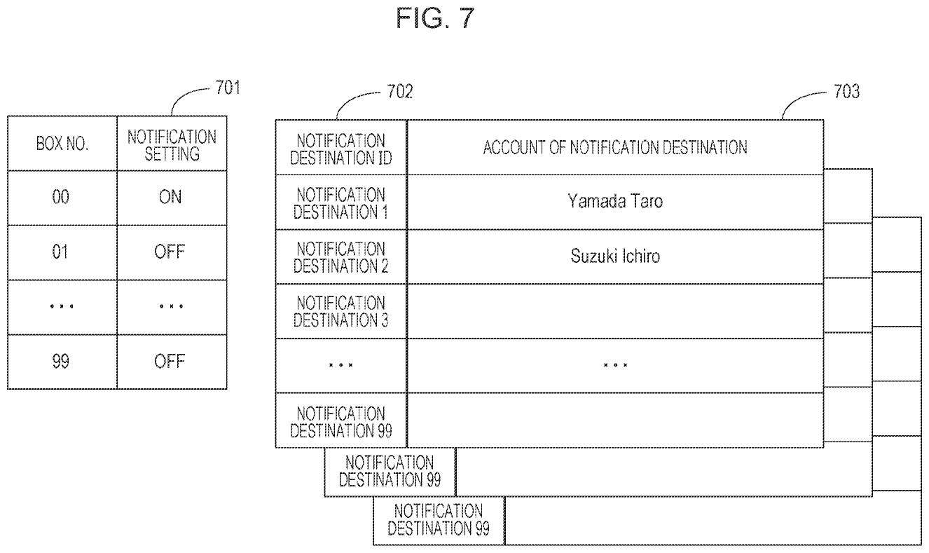

In step S503, the image forming apparatus 30 determines whether a notification setting (FIG. 7) corresponding to the storage of the document data to the box No. 00 is set. When the notification setting (FIG. 7) is set (when the notification setting is ON), the image forming apparatus 30 generates document storage notification information to notify a notification destination indicated by the notification setting (FIG. 7) that the document data has been stored, and transmits the document storage notification information to the message server 20.

In step S504, the message server 20 transmits a message to the terminal server 10 based on the document storage notification information transmitted in step S503.

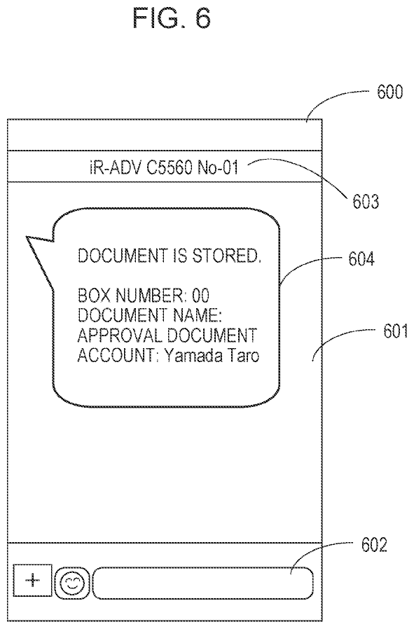

Next, an example of an operation according to the present embodiment is described with reference to FIG. 6. FIG. 6 is a diagram illustrating an example of a display screen 600 displayed on the display unit 110 when the control unit 100 of the terminal device 10 reads and executes the messenger application 142 in step S504. The display screen 600 includes an area 601 for displaying a timeline and an area 602 for entering and displaying a message.

In the area 601 for displaying the timeline, messages are displayed in chronological order. In the area 601, an area for displaying image data and an area for displaying based on posted content for each message, like the area 604 for displaying posted content of a text message, are secured. Every time a message is stored in the message storage area 146, the control unit 100 updates display of the area 601 for displaying the message to present, to the user of the terminal device 10, the message communicated between the terminal device 10 and the image forming apparatus 30.

In the area 603, the account name of the image forming apparatus 30 is displayed as a partner (destination of the message) that communicates the message. However, in the area 603, the account name of the image forming apparatus 30 may be displayed as an icon or the name (for example, the name of the user) of the partner may be displayed as the account name of the image forming apparatus 30. The name of the partner and information of the icon of the partner may be included in the message, and the control unit 100 may store the name of the partner and the icon of the partner to the storage unit 140.

In the area 604, information indicating that the document data is stored in the box of the image forming apparatus 30 is displayed based on the content of the message transmitted in step S504. The user who operates the terminal device 10 can know, from the display of the area 604, that the document data of an “approval document” has been stored in the box No. 00 based on an account “Yamada Taro”.

Next, a setting value of the notification setting for the box NO. 00 of the image forming apparatus 30 is described with reference to FIG. 7. FIG. 7 illustrates an example of the setting value for the box No. 00. In FIG. 7, a similar setting value is set for each of some or all of the boxes managed by the image forming apparatus 30. 701 indicates a notification setting that is set to ON or OFF for each of the boxes. 702 indicates a notification ID for each of the boxes. Notification destinations are managed based on IDs of 1 to 99 for each of the boxes. 703 indicates an account of a notification destination for each of the boxes. The destination of the message transmitted in step S504 can be determined based on the account 703 of the notification destination. The notification settings 701 may be also referred to as information 701. The accounts 703 of the notification destinations may be also referred to as setting information 703.

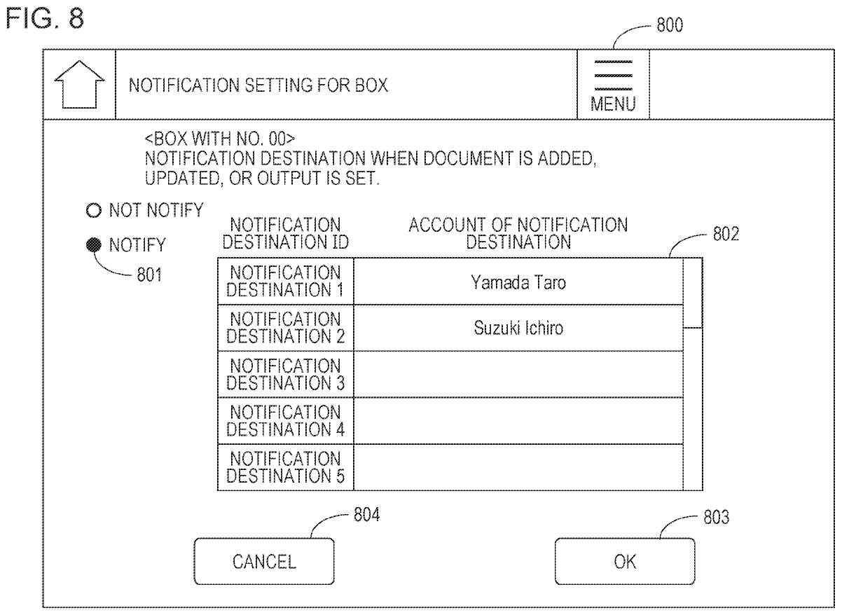

Next, an example of a screen 800 for setting notification setting information of the box No. 00 illustrated in FIG. 7 is described with reference to FIG. 8. The screen 800 is an example of a screen displayed on the display unit 330 of the image forming apparatus 30 for a notification setting for a box. A radio button 801 indicates selection of whether a notification is to be issued for storage of document data, and corresponds to a setting value of ON or OFF of a notification setting 701 illustrated in FIG. 7. When “Notify” is selected in the radio button 801, the setting value for the box No. 00 in the notification setting 701 is set to ON and a notification destination account setting in an area 802 is set to be valid.

In the area 802, notification settings for notification destinations 1 to 99 can be set, and it is possible to edit and enter accounts of the notification destinations by selecting items of the accounts of the notification destinations for each of the notification IDs.

The image forming apparatus 30 can reflect the notification settings illustrated in FIG. 8 in setting values illustrated in FIG. 7 in response to pressing of an OK button 803, and cancel the settings in response to pressing of a cancel button 804.

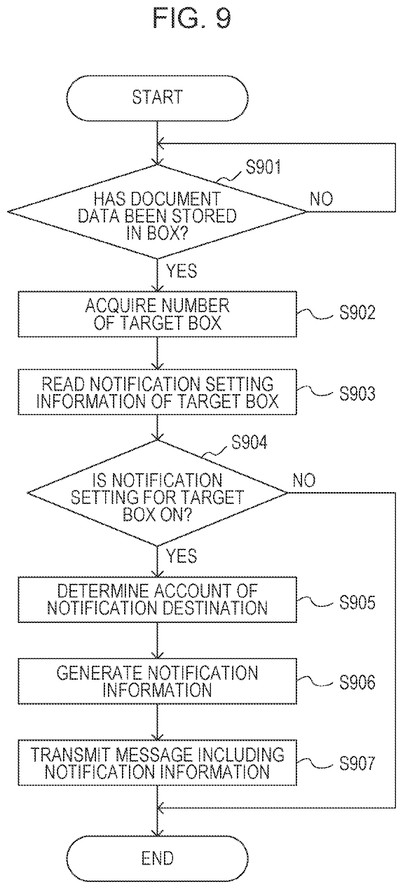

FIG. 9 is a flowchart illustrating a method of controlling the image forming apparatus 30. Details of the process of issuing a document storage notification in step S503 are described with reference to the flowchart of FIG. 9. The flowchart of FIG. 9 is implemented by the control unit 300 of the image forming apparatus 30 controlling the image input unit 310, the image forming unit 320, the display unit 330, the operation input unit 340, the storage unit 350, and the communication unit 360.

In step S901, the control unit 300 determines whether new document data has been stored in a box. That is, the control unit 300 determines whether the processing in step S502 illustrated in FIG. 5 has been performed to store the new document data in the image data storage area 352. When the new document data is not stored in the box, the process returns to step S901. When the new document data is stored in the box, the process proceeds to step S902.

In step S902, the control unit 300 acquires, as a number of the target box, a number of the box in which the document data has been stored. In the present embodiment, the control unit 300 acquires No. 00 as the number of the target box.

In step S903, the control unit 300 reads notification setting information of the target box described with reference to FIG. 7. In the present embodiment, the control unit 300 reads the setting value for the box No. 00.

In step S904, the control unit 300 determines, based on the notification setting information read in step S903, whether the notification setting 701 for the target box is ON. When the notification setting 701 for the target box is ON, the process proceeds to step S905 to perform a message notification process. When the notification setting 701 for the target box is OFF, the message notification process is not necessary and the process of the flowchart illustrated in FIG. 9 ends.

In step S905, the control unit 300 determines an account of a message notification destination based on the notification setting information read in step S903.

In step S906, the control unit 300 generates document storage notification information for issuing a message notification. For example, the control unit 300 acquires, from the document storage request received in step S501, the box number, the document name, the name of the account for which the document has been stored, and the like, generates the document storage notification information, and stores the document storage notification information to the storage unit 350.

In step S907, the control unit 300 transmits a message including the document storage notification information generated in step S906 for the account of the message notification destination determined in step S905 to the terminal device 10 via the message server 20.

According to the present embodiment described above, when document data is stored in a box, the image forming apparatus 30 can transmit a document storage notification to only an appropriate notification destination based on a notification setting set for the box.

Although the storage of the document data in step S901 is described above, the storage is not limited thereto. The storage can be applied when document data is manipulated in the boxes. The boxes are an example of storage sections, and are, for example, folders. The document data may be data such as image data excluding document data. The data is, for example, files.

As described above, on the screen 800 illustrated in FIG. 8, the control unit 300 and the storage unit 350 cooperate to act as a setting unit that sets, as the setting information illustrated in FIG. 7, the information 701 indicating whether a notification is to be issued for each of the boxes illustrated in FIG. 7, and the accounts 703 of the notification destinations set for each of the boxes.

In steps S501 and S502 illustrated in FIG. 5, the control unit 300 and the storage unit 350 cooperate to act as an operation unit that manipulates data in a box upon receiving a request to manipulate the box. For example, the manipulation of the data is storing or updating of the data in the box, or an instruction to print the data in the box.

In step S902 illustrated in FIG. 9, the control unit 300 and the storage unit 350 cooperate to act as an identifying unit that identifies, when data is manipulated in a box, the box in which the data has been manipulated from among the plurality of boxes.

In step S903, the control unit 300 reads the setting information illustrated in FIG. 7. The setting information illustrated in FIG. 7 includes the information 701 indicating whether a notification is to be issued for each of the boxes, and the setting information 703 in which a notification destination is set for each of the boxes.

In step S904, based on the information 701 illustrated in FIG. 7, the control unit 300 advances the process to step S905 when a notification for the box identified in step S902 is to be issued (ON). In step S904, based on the information 701 illustrated in FIG. 7, the control unit 300 ends the process of the flowchart illustrated in FIG. 9 without transmitting notification information when a notification for the box identified in step S902 is not to be issued (OFF).

In step S905, the control unit 300 and the storage unit 350 cooperate to act as an acquirer that acquires information indicating a notification destination corresponding to the box identified in step S902, based on the setting information in which a notification destination is set for each of the boxes.

In step S907, the control unit 300 and the storage unit 350 cooperate to act as a transmitter that transmits, to the notification destination indicated by the information acquired in step S905, notification information indicating that the data has been manipulated. Specifically, the control unit 300 transmits a message indicating that the data has been manipulated to the notification destination indicated by the information acquired in step S905 via the message server 20 that provides the messaging service.

The notification information described above is transmitted to display, as a timeline, the message indicating that the data has been manipulated to the notification destination acquired in step S905. As indicated by the area 604 illustrated in FIG. 6, the notification information includes information indicating the box identified in step S902, the name of the data manipulated, or the name of an account for which the data has been manipulated.

According to the present embodiment, when data is manipulated in the boxes, the image forming apparatus 30 can transmit to an appropriate notification destination set for each of the boxes, a message indicating that the data has been manipulated.

### Second Embodiment

Next, a second embodiment is described. In the second embodiment, in addition to the first embodiment, when printing is interrupted due to a paper jam or no paper during printing in the image forming apparatus 30, a passcode necessary for restarting the printing is notified. In the second embodiment, only parts that are different from the first embodiment are described and functions and processing that are identical to those described in the first embodiment are not described.

### Process Procedure

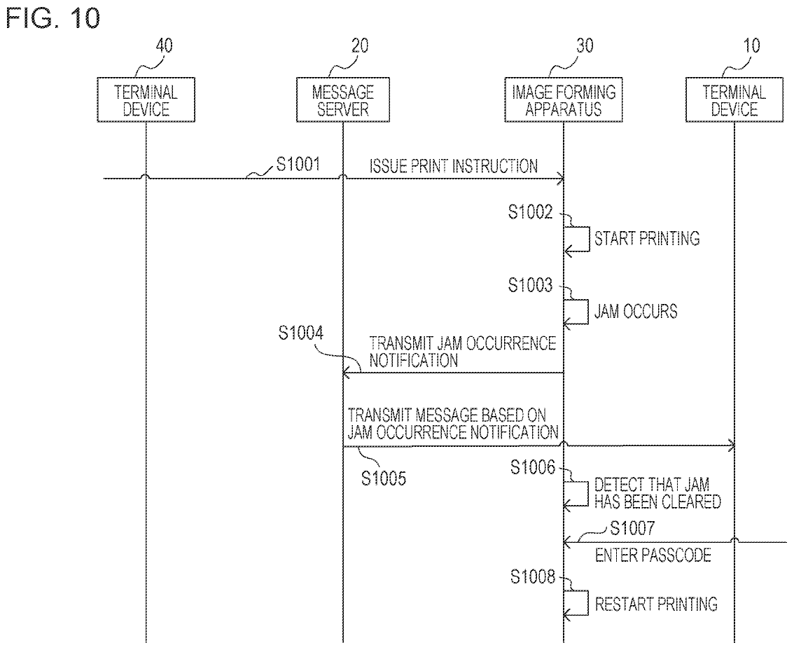

FIG. 10 is a sequence diagram illustrating a process procedure of the terminal devices 10 and 40, the message server 20, and the image forming apparatus 30 according to one embodiment. It is assumed that a user of the terminal device 10 and the image forming apparatus 30 are users of a messaging service and that an account is allocated to each of the user of the terminal device 10 and the image forming apparatus 30. In addition, it is assumed that the user of the terminal device 10 and the image forming apparatus 30 can transmit and receive a message to and from each other.

First, in step S1001, a user designates document data stored in the box No. 00 of the image forming apparatus 30 and issues an instruction to print the document data via the display unit 330 and the operation input unit 340 of the image forming apparatus 30.

Next, in step S1002, the control unit 300 of the image forming apparatus 30 reads the document data from the print data storage area 354 in response to the print instruction issued in step S1001, functions as the print data generator 304 to generate print data based on the document data. The control unit 300 causes the image forming unit 320 to generate a print job based on the print data and start to form an image. The control unit 300 stores, to the storage unit 350, information indicating that the print job has been generated from the document data stored in the box No. 00.

Next, in step S1003, the control unit 300 detects the occurrence of a jam of printing paper and interrupts a print process. When the print process is interrupted due to the jam of the printing paper, the user needs to remove the jammed printing paper and restart the print process.

Next, in step S1004, in a case where a notification setting is set for the box No. 00 that is the storage location of the document data being subjected to the print process, the control unit 300 transmits, to the message server 20, a jam occurrence notification indicating that the printing paper is being jammed. The jam occurrence notification includes a passcode for restarting the print process.

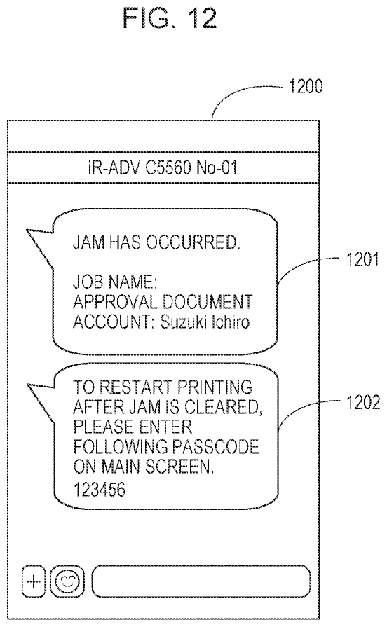

In step S1005, the message server 20 transmits, to the terminal device 10, a message based on the jam occurrence notification received in step S1004. Upon receiving the message, the terminal device 10 displays, on the display unit 110, a display screen 1200 indicating the content of the message. The displayed content is described later. FIG. 12 illustrates the display screen 1200. The passcode for restarting the print process is displayed on an area 1202 included in the display screen 1200.

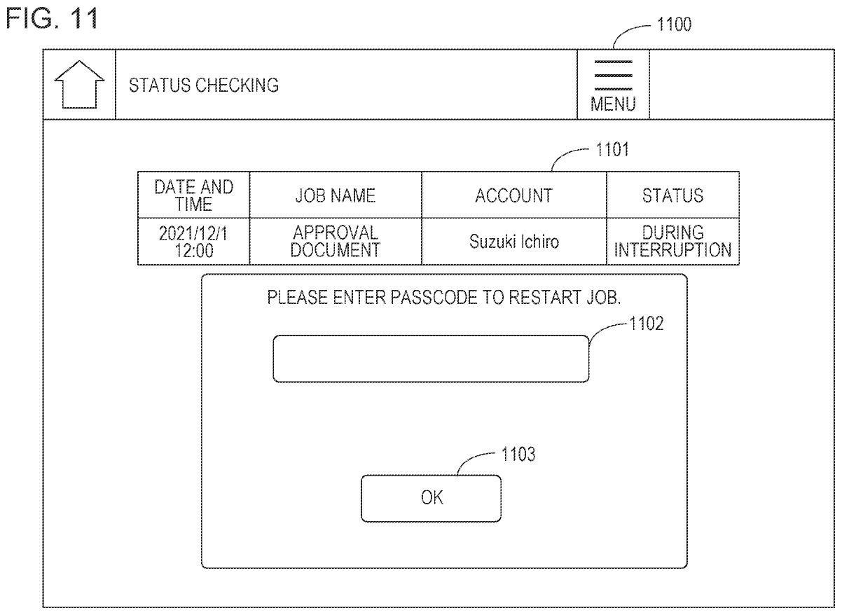

In step S1006, when the jam of the printing paper is cleared by a user's operation, the control unit 300 detects that the jam has been cleared. The jam of the printing paper can be cleared by any user. Therefore, when the print process is restarted immediately after the clearing of the jam, even a user who does not have the right to access the box No. 00 can obtain a printed material. Therefore, the control unit 300 controls the display unit 330 to display a passcode entry screen 1100 illustrated in FIG. 11 after the clearing of the jam.

In step S1007, the user enters a passcode for restarting the print process from the operation input unit 340 based on the passcode displayed in the area 1202 illustrated in FIG. 12.

In step S1008, the control unit 300 restarts the print process when the passcode entered in step S1007 matches the passcode included in the jam occurrence notification transmitted in step S1004.

Next, the passcode entry screen 1100 displayed in step S1006 is described with reference to FIG. 11. The passcode entry screen 1100 is an example of the passcode entry screen displayed on the display unit 330 by the control unit 300. 1101 indicates a target print job, and an execution date and time of the print job, the name of the job, the name of an account for which an execution command was issued, and a state are displayed. 1102 indicates a passcode entry field for entering a passcode for restarting printing. The user can enter a passcode in the passcode entry field 1102 via the operation input unit 340. 1103 indicates an OK button. The user presses the OK button 1103 to instruct to determine the passcode entered in the passcode entry field 1102.

Next, an example of an operation according to the present embodiment is described with reference to FIG. 12. FIG. 12 is a diagram illustrating an example of the display screen 1200 displayed on the display unit 110 when the control unit 100 of the terminal device 10 reads and executes a messenger application 142 in step S1005.

In an area 1201, the message indicating that the jam has occurred is displayed together with the name of the job and the account name based on the jam occurrence notification. Based on the area 1201, the user who uses the terminal device 10 can know that the jam has occurred in the job. In the area 1202, information indicating that a passcode needs to be entered to restart the print process each time a jam is recovered and that the passcode is 123456 is displayed. Based on the area 1202, the user who uses the terminal device 10 can know the passcode necessary to restart the print process.

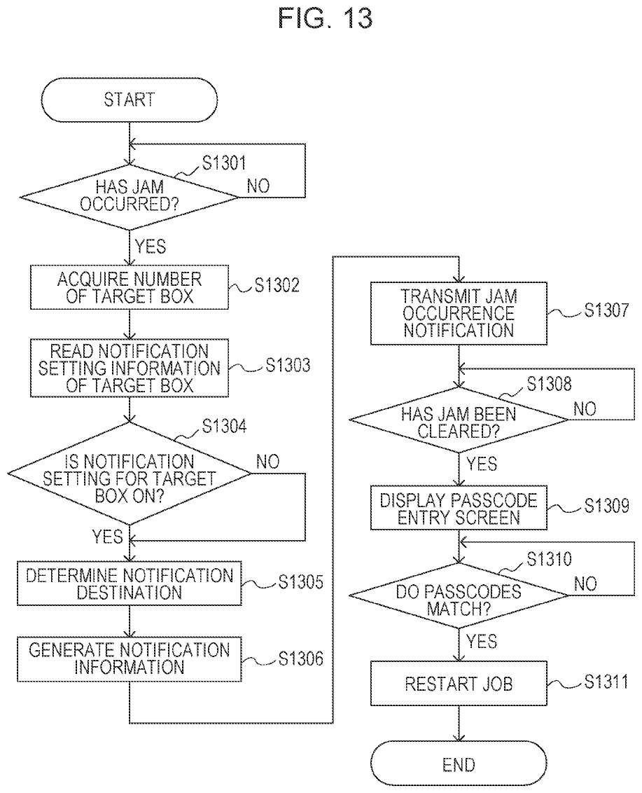

FIG. 13 is a flowchart illustrating a method of controlling the image forming apparatus 30. A process of the image forming apparatus 30 in steps S1003 to S1008 illustrated in FIG. 10 is described with reference to the flowchart illustrated in FIG. 13. The flowchart illustrated in FIG. 13 is implemented by the control unit 300 controlling the image input unit 310, the image forming unit 320, the display unit 330, the operation input unit 340, the storage unit 350, and the communication unit 360.

In step S1301, the control unit 300 causes the image forming unit 320 to detect a jam of printing paper. When the control unit 300 detects the jam of the printing paper, the process proceeds to step S1302.

In step S1302, the control unit 300 acknowledges that the print job stored in the storage unit 350 in step S1002 has been generated from the document data stored in the box No. 00. Then, the control unit 300 acknowledges that the print job has been generated in accordance with the instruction to print the document data stored in the box No. 00. The control unit 300 acquires the number of the box in which the document data was stored. In the present embodiment, the control unit 300 acquires the box number 00 as the number of the box in which the document data was stored.

In step S1303, the control unit 300 reads notification setting information of the target box described with reference to FIG. 7 in a similar manner to step S903 illustrated in FIG. 9.

In step S1304, the control unit 300 determines whether a notification setting 701 for the target box is ON, based on the notification setting information read in step S1303. Regardless of whether the notification setting 701 for the target box is ON or OFF, the process proceeds to step S1305.

In step S1305, the control unit 300 determines an account of a message notification destination based on the notification setting information read in step S1303.

Next, in step S1306, the control unit 300 generates notification information for transmitting the jam occurrence notification transmitted in step S1004. The control unit 300 reads, from the storage unit 350, the name of the job, the name of the account for which a command to execute the job has been issued, and the like, generates a passcode for restarting the print job after the clearing of the jam, generates jam occurrence notification information, and stores the jam occurrence notification information to the storage unit 350. The jam occurrence notification information includes the passcode.

Next, in step S1307, the control unit 300 transmits, to the terminal device 10 via the message server 20, the jam occurrence notification transmitted in step S1004 for the account of the message notification destination determined in step S1305, based on the jam occurrence notification information. The jam occurrence notification includes the passcode.

Next, in step S1308, the control unit 300 determines whether the control unit 300 has detected the clearing of the jam by the user's operation in step S1006. When the control unit 300 does not detect the clearing of the jam, the process returns to step S1308. When the control unit 300 detects the clearing of the jam, the process proceeds to step S1309.

In step S1309, the control unit 300 controls the display unit 330 to display the passcode entry screen 1100 described with reference to FIG. 11.

Next, in step S1310, the control unit 300 determines whether a passcode entered from the operation input unit 340 matches the passcode generated in step S1306.

When the passcode entered from the operation input unit 340 does not match the passcode generated in step S1306, the process returns to step S1310. When the passcode entered from the operation input unit 340 matches the passcode generated in step S1306, the process proceeds to step S1311.

In step S1311, the control unit 300 restarts the above-described print job and continues to form the image.

As described above, according to the present embodiment, when printing paper is jammed during printing of document data stored in a box, the image forming apparatus 30 requires an entry of a passcode transmitted in a jam occurrence notification for restart of a print job after the clearing of the jam. As a result, a user who can restart the print job after the clearing of the jam can be limited to only a user who has received the jam occurrence notification, and it is possible to prevent an undesignated user from restarting the print job to obtain a printed material.

Similar to the first embodiment, the control unit 300 and the storage unit 350 cooperate to act as a setting unit that sets, as the setting information illustrated in FIG. 7, information 701 indicating whether a notification is to be issued for each of boxes as illustrated in FIG. 7, and accounts 703 of notification destinations set for each of the boxes on the screen 800 illustrated in FIG. 8. For example, the boxes are, for example, folders.

In steps S1001 and S1002 illustrated in FIG. 10, the control unit 300 functions as a start controller and performs control to start to execute the print job on the data stored in the box based on the command to execute the print job on the data stored in the box. For example, the data is a file.

In step S1302 illustrated in FIG. 13, when the execution of the print job on the data stored in the box is interrupted, the control unit 300 identifies the box storing the data for the print job from among the plurality of boxes. For example, the interruption of the print job is caused by the occurrence of the jam.

In step S1303, the control unit 300 reads the setting information illustrated in FIG. 7. The setting information illustrated in FIG. 7 includes the information 701 indicating whether a notification is to be issued for each of the boxes, and setting information 703 in which a notification destination is set for each of the boxes.

In step S1305, the control unit 300 acquires information indicating a notification destination corresponding to the box identified in step S1302, based on the setting information in which the notification destinations are set for each of the boxes.

In step S1307, the control unit 300 transmits, to the notification destination indicated by the information acquired in step S1305, notification information indicating that the execution of the print job has been interrupted. Specifically, the control unit 300 transmits a message indicating that the execution of the print job has been interrupted to the notification destination indicated by the information acquired in step S1305 via the message server 20 that provides the messaging service.

The notification information described above is transmitted to display, as a timeline, a message indicating that the execution of the print job has been interrupted to the notification destination indicated by the information acquired in step S1305. Similar to the area 1201 illustrated in FIG. 12, the notification information includes the name of the print job or the name of an account for which the command to execute the print job has been issued. In addition, similar to the area 1202 illustrated in FIG. 12, the notification information includes a passcode for restarting to execute the print job.

In step S1308, the control unit 300 functions as a determiner and determines whether the control unit 300 has detected the clearing of the jam. When the control unit 300 determines that the control unit 300 has detected the clearing of the jam, the process proceeds to step S1309.

In step S1310, the control unit 300 functions as a display controller and performs control to display the area 1102 for entering a passcode for restarting to execute the print job as illustrated in FIG. 11.

In step S1311, the control unit 300 functions as a restart controller and performs control to restart to execute the interrupted print job when the entered passcode matches the passcode included in the notification information.

According to the present embodiment, when the execution of a print job on data stored in the boxes is interrupted, the image forming apparatus 30 can transmit, to an appropriate notification destination set for each of the boxes, a message indicating that the execution of the print job has been interrupted.

### OTHER EMBODIMENTS

Various embodiments of the present disclosure can be implemented by a process in which a program that implements one or more of the functions described herein is supplied to a system or an apparatus via a network or a storage medium, and one or more processors in a computer of the system or of the apparatus read and execute the program. Various embodiments of the present disclosure can also be implemented in whole or in part by a circuit (for example, an ASIC that implements one or more of the functions described herein).

The above-described embodiments merely provide specific examples of implementations of the features described in the present disclosure. The technical scope of the present invention is not limited to the described embodiments. That is, embodiments of the present disclosure can be implemented in various forms without departing from the technical idea or spirit of the main features described in the present disclosure.

According to various embodiments of the present disclosure, it is possible to transmit notification information to a notification destination appropriate for each of storage sections.

### OTHER EMBODIMENTS

Various embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-042822, filed Mar. 17, 2023, which is hereby incorporated by reference herein in its entirety.

What is claimed is:

1. An image forming apparatus comprising:
at least a processor and at least a memory coupled to the at least the processor and having stored thereon instructions, when executed by the at least the processor, and cooperating to act as:
an identifying unit configured to identify, when data is manipulated in a storage section, the storage section in which the data has been manipulated, from among a plurality of storage sections;
an acquirer configured to acquire information indicating a notification destination corresponding to the storage section identified by the identifying unit, based on setting information in which a notification destination is set for each of the storage sections; and
a transmitter configured to transmit, to the notification destination indicated by the information acquired by the acquirer, notification information indicating that the data has been manipulated.

2. The image forming apparatus according to claim 1, wherein
the notification information is transmitted to display, as a timeline, a message indicating that the data has been manipulated to the notification destination indicated by the information acquired by the acquirer.

3. The image forming apparatus according to claim 1, wherein
the notification information includes information indicating the storage section identified by the identifying unit, a name of the data manipulated, or a name of an account for which the data has been manipulated.

4. The image forming apparatus according to claim 1, wherein
the setting information includes information indicating whether a notification is to be issued for each of the storage sections, and
when a notification is to be issued for the storage section identified by the identifying unit, the transmitter transmits the notification information based on the setting information, and when a notification is not to be issued for the storage section identified by the identifying unit, the transmitter does not transmit the notification information.

5. The image forming apparatus according to claim 1, wherein
the at least the processor and the at least the memory cooperate to act as a setting unit configured to set, as the setting information, a notification destination for each of the storage sections.

6. The image forming apparatus according to claim 4, wherein
the at least the processor and the at least the memory cooperate to act as a setting unit configured to set, as the setting information, information indicating whether a notification is to be issued for each of the storage sections, and a notification destination for each of the storage sections.

7. The image forming apparatus according to claim 1, wherein
the manipulation of the data is storing or updating of the data in the storage section or an instruction to print the data.

8. The image forming apparatus according to claim 1, wherein
the storage sections are folders, and
the data is files.

9. The image forming apparatus according to claim 2, wherein
the transmitter transmits a message indicating that the data has been manipulated to the notification destination indicated by the information acquired by the acquirer via a message server that provides a messaging service.

10. The image forming apparatus according to claim 1, wherein
the at least the processor and the at least the memory cooperate to act as an operation unit configured to manipulate the data in the storage section upon receiving a request to manipulate the storage section.

11. An image forming apparatus comprising:
at least a processor and at least a memory coupled to the at least the processor and having stored thereon instructions, when executed by the at least the processor, and cooperating to act as:
an identifying unit configured to identify a storage section that stores data for a print job from among a plurality of storage sections when execution of the print job on the data stored in the storage section is interrupted;
an acquirer configured to acquire information indicating a notification destination corresponding to the storage section identified by the identifying unit, based on setting information in which a notification destination is set for each of the storage sections; and
a transmitter configured to transmit, to the notification destination indicated by the information acquired by the acquirer, notification information indicating that the execution of the print job has been interrupted.

12. The image forming apparatus according to claim 11, wherein
the interruption of the print job is caused by occurrence of a jam.

13. The image forming apparatus according to claim 11, wherein
the notification information is transmitted to display, as a timeline, a message indicating that the execution of the print job has been interrupted to the notification destination indicated by the information acquired by the acquirer.

14. The image forming apparatus according to claim 11, wherein
the notification information includes a name of the print job or a name of an account for which a command to execute the print job has been issued.

15. The image forming apparatus according to claim 11, wherein
the notification information includes a passcode for restarting to execute the print job.

16. The image forming apparatus according to claim 15, further comprising
a restart controller configured to perform to restart to execute the interrupted print job when an entered passcode matches the passcode included in the notification information after the transmission by the transmitter.

17. The image forming apparatus according to claim 16, further comprising
a display controller configured to perform control to display an area for entering a passcode for restarting to execute the print job after the transmission by the transmitter.

18. The image forming apparatus according to claim 16, wherein
the interruption of the print job is caused by occurrence of a jam,
the image forming apparatus further comprises a determiner configured to determine whether the determiner has detected clearing of the jam after the transmission by the transmitter, and
the restart controller performs control to restart to execute the interrupted print job when an entered passcode matches the passcode included in the notification information after the determiner determines that the determiner has detected the clearing of the jam.

19. The image forming apparatus according to claim 11, wherein
the at least the processor and the at least the memory cooperate to act as a setting unit configured to set, as the setting information, a notification destination for each of the storage sections.

20. The image forming apparatus according to claim 11, wherein
the storage sections are folders, and
the data is files.

21. The image forming apparatus according to claim 13, wherein
the transmitter transmits a message indicating that the execution of the print job has been interrupted to the notification destination indicated by the information acquired by the acquirer via a message server that provides a messaging service.

22. The image forming apparatus according to claim 11, further comprising
a start controller configured to perform control to start to execute the print job on the data stored in the storage section based on a command to execute the print job on the data stored in the storage section.

23. A method executed by at least one processor in an image forming apparatus, the method comprising:
identifying, when data is manipulated in a storage section, the storage section in which the data has been manipulated, from among a plurality of storage sections;
acquiring information indicating a notification destination corresponding to the storage section identified by the identifying, based on setting information in which a notification destination is set for each of the storage sections; and
transmitting, to the notification destination indicated by the information acquired by the acquiring, notification information indicating that the data has been manipulated.

24. A method executed by at least one processor in an image forming apparatus, the method comprising:
identifying a storage section that stores data for a print job from among a plurality of storage sections when execution of the print job on the data stored in the storage section is interrupted;
acquiring information indicating a notification destination corresponding to the storage section identified by the identifying, based on setting information in which a notification destination is set for each of the storage sections; and
transmitting notification information indicating that the execution of the print job has been interrupted to the notification destination indicated by the information acquired by the acquiring.
